(19) United States
(12) Patent Application Publication
(10) Pub. No.: US 2018/0342139 A1
(43) Pub. Date: Nov. 29, 2018

(54) LIFESAVERHD: A COMPUTER HARDWARE AND SOFTWARE PROGRAM FOR SAFETY, DETECTION, ALERT SYSTEM AND ASSET TRACKING

(71) Applicant: LOUIS UKUNI OTAVIO, BUCKEYE, AZ (US)

(72) Inventor: LOUIS UKUNI OTAVIO, BUCKEYE, AZ (US)

(21) Appl. No.: 15/978,057

(22) Filed: May 11, 2018

(51) Int. Cl. G08B 21/02; G08B 21/18; H04W 4/90; H04M 1/2745

(52) U.S. Cl. CPC G08B 21/02; H04M 1/274533; H04W 4/90; G08B 21/182

(57) ABSTRACT

To date, no one has written a combined computer program or has built a hardware to detect the presence of an occupant in a car during extreme temperatures; presence of a pet or a child near a swimming pool, presence of an intruder near a house, and presence of a living object in a house during extreme temperatures. The purpose of this invention is to add to the existing body of invention a software program and a hardware that uses micro-controller (a motherboard or brain of a computer), temperature sensor, motion sensor, Internet service or connection, Bluetooth or Wi-Fi, security camera, infra-red sensor and other sensors, a power system (battery or wall plugin) and global positioning system (gps) to aid detect:
1. Presence of an occupant or a living object in a car during extreme temperatures
2. Presence of a child or a pet near a swimming pool
3. Presence of an intruder near a house
4. Presence of a living object in a house during extreme temperatures and
5. To aid provide an asset tracking system

### FIELD OF THE INVENTION

The invention relates to a computer software program and hardware for safety, alert and detection system to protect humans or animals from a potential injury or death when locked in a vehicle or a house with a high temperature condition. To detect presence of a child near a swimming pool or an intruder near a house and to provide an asset tracking system.

### BACKGROUND OF THE INVENTION

According to the statistics by the National Highway Traffic Safety Administration, since 1998 to present, 645 children have died from heat-related stroke in the United States while being accidently left in locked vehicles¹⁾. Furthermore, countless pets, such as dogs and cats have suffered temperature related injuries, or death by being locked in hot vehicles accidentally or intentionally.

Unfortunately, up to the current moment, no any inventor has come with a market-ready product to alleviate accidentally heat-related deaths apart from conceptual and hypothetical solutions offered on pieces of paper. As a result, heat-associated death in the United States and other parts of the world has become a common phenomenon even though most of these deaths are preventable through outreach and intervention.

Similarly, according to the World Health Organization, drowning is the leading cause of unintentional death in the world, with 372,000 drowning deaths reported annually²⁾. The study has also shown that about 75 percent of drowning cases are of children younger than 15 years of age and most of the swimming pool-related drownings occur at swimming pools located at private residential houses or at a neighbor's swimming pool²⁾. As a result, children are found to more likely drown or suffer a swimming pool-related injury when they are left unsupervised near a swimming pool²⁾.

Hence, the purpose of this invention is to present a computer software program that is market-ready for lifesaving, safety detection and alert system with functional hardware units, PCB layout, schematic designs and Gerber files slated for mass production.

### BRIEF SUMMARY OF THE INVENTION

In order to overcome the issues described above, the present invention provides a computer hardware and software program for safety, detection and an alert system which can prevent potential death or injury or security hazard by detecting and alerting the presence of an occupant or a living object in a car or inside a house during extreme temperatures, presence of a child or a pet near a swimming pool or an intruder near a house and assist in an asset tracking.

The present invention provides a detection system that determines whether humans or animals are present in a vehicle or a house when the internal temperature is above or below the normal threshold. The device then sends text messages with emergency alerts, make phone calls with pre-corded messages to emergency contacts through a sim card with activated cellular line and phone number, and triggers an alarm.

The present invention provides communication with motion sensor, temperature sensor, a camera and cellular line via data plan, Internet service, Wi-Fi or Bluetooth.

The present invention provides co-ordinates with Google map for locating the victim by using global positioning system or GPS antennae that can also be used for an asset tracking.

### BRIEF DESCRIPTION OF THE DRAWINGS

A complete understanding of the present invention and its advantages are acquired by following description of drawings.

FIG. 1 is the schematic diagram of hardware components of the safety alert system.

FIG. 2 is the command protocol of the software program.

### DETAILED DESCRIPTION OF THE INVENTION

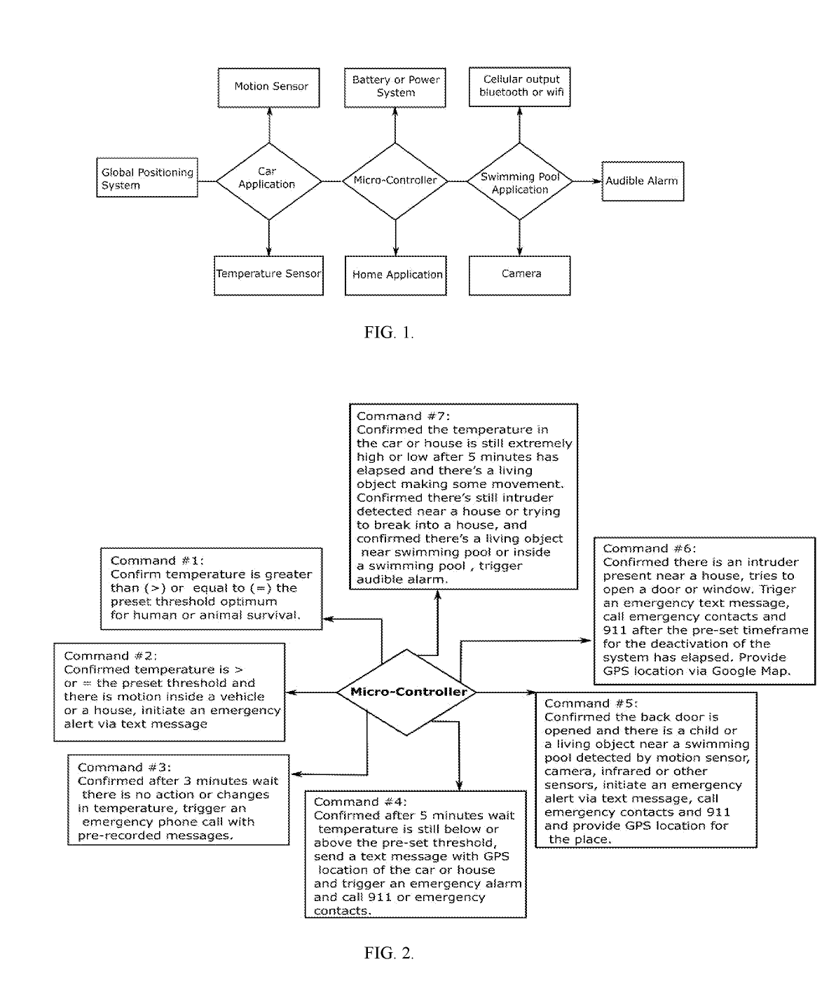

FIG. 1 shows the hardware components of the safety alert system of the present invention, which includes a micro-controller, a temperature sensor, a camera, a motion sensor, battery or power system, communication system, audible alarm system and global positioning system.

Temperature sensor detects an internal temperature exceeds acceptable threshold for human and animal survival. Temperature sensor relays the message to the micro-controller.

Motion sensor detects locomotion or movement inside a car or a house due to the presence of human or animal and sends the message to micro-controller.

Embedded cellular sim card with activated phone number inside the micro-controller sends text messages, make phone calls with pre-corded messages to emergency contacts, calls 911 and triggers a siren when internal temperature has become extremely high or low and there is a pet or a human present in the car making locomotion.

Global positioning system or GPS antennae provides co-ordinates with Google map for locating the victim as well as an asset tracking.

FIG. 2 shows the command protocol of the software program, which are the executing actions corresponding to the relayed messages to the micro-controller from the detecting components, temperature sensor, motion sensor, gps antennae and camera.

Command #1: Confirm temperature is greater than (>) or equal to (=) the preset threshold optimum for human or animal survival.

Command #2: Confirm temperature is > or =the preset threshold and there is motion inside a vehicle or a house, initiate an emergency alert via text message.

Command #3: Confirm after 3 minutes wait there is no action or changes in temperature, trigger an emergency phone call with pre-recorded messages.

Command #4: Confirm after 5 minutes wait, temperature is still below or above the pre-set threshold, send a text message with GPS location of the car or house and trigger an emergency alarm and call 911 or emergency contacts.

Command #5: Confirm the back door is opened and there is a child or a living object near a swimming pool detected by motion sensor, camera, infrared or other sensors, initiate an emergency alert via text message, call emergency contacts and 911 and provide GPS location of the place.

Command #6: Confirm there is an intruder present near a house, tries to open a door or window. Trigger an emergency text message, call emergency contacts and 911, trigger an audible alarm after the pre-set timeframe for the deactivation of the system has elapsed. Provide GPS location of the place via Google Map.

Command #7: Confirm the temperature inside the car or house is still extremely high or low after 5 minutes has elapsed and there's a living object making some movement. Confirm there's an intruder detected near a house or trying to break into a house, and confirm there's a living object near a swimming pool or inside a swimming pool, trigger an audible alarm.

Home Application

Temperature sensor detects temperature that exceeds acceptable threshold for human and animal survival inside a house. Temperature sensor relays the message to the micro-controller.

Motion sensor detects locomotion or movement inside a house due to the presence of human or animal and sends the message to the micro-controller.

Embedded cellular sim card with an activated phone number inside the micro-controller sends text messages, makes phone calls with pre-corded messages to emergency contacts, calls 911 and triggers a siren after when temperature reaches extremely high or low threshold and there is a pet or a human present in the house or room making a locomotion.

Global positioning system or GPS antennae provides co-ordinates with Google map for locating the victim.

Alternatively, in home security situation, system detects presence of an intruder with the aid of the motion sensor. Motion sensor relays the information to the micro-controller that triggers an alarm, sends text messages or calls 911.

Swimming Pool Application

The motion sensor and camera detect the presence of locomotion near a swimming pool. It relays the message to the micro-controller that sends text messages, pre-recorded messages and calls 911 and triggers an audible alarm.

From the above description of various embodiments of the present invention, it is evident that the objectives of the invention are attained. Therefore, the scope described in the invention shall be limited solely by the claims appended hereto.
1. A software program that is written and programmed to send commands from the motherboard of the micro-controller to the temperature sensor when temperature reaches a certain threshold not optimum for human or animal survival (extremely low temperature or extremely high temperature).
2. A software program that is written to accommodate up to fifteen emergency contacts including 911 to send pre-recorded messages, text messages and make phone calls from a cellular line embedded in a sim module within the micro-controller.
3. A software program that is written to command the motion sensor to detect and relay to the micro-controller the presence of an object in a car, near a house or inside a house, and in a swimming pool or near a swimming pool.
4. A software program that is written to allow the motion sensor, temperature sensor, the camera and the cellular line to communicate via home or in car Internet service, Wi-Fi or Bluetooth.
5. A software program that is written to trigger a siren or an alarm when a temperature is out of the programmed parameters and there is a living object present in a car or in a house.
6. A software program that is written to trigger a siren when a motion sensor detects an intruder or a living object near or inside a swimming pool.
7. An asset tracking system aided by an embedded sim card with an activated cellular line and a gps antennae.
8. Hardware components incorporated in the micro-controller to performed the above stated functions.

1. (canceled)

2. (canceled)

3. (canceled)

4. (canceled)

5. (canceled)

6. (canceled)

7. (canceled)

8. (canceled)

9. A software program that is written and programmed to send commands from the motherboard of the micro-controller to the temperature sensor when temperature reaches a certain threshold not optimum for human or animal survival (extremely low temperature or extremely high temperature) or a software program that is written and programmed to accommodate upto fifteen (15) emergency contacts including 911 to send pre-recorded messages, text messages and make phone calls from a cellular line embedded in a sim module within the micro-controller based on programmable wireless or Internet of things technological platform.

10. A software program that is written to command the motion sensor to detect and relay to the micro-controller the presence of an object in a car, near a house or inside a house, and in a swimming pool or near a swimming pool or a software program that is written to allow the motion sensor, temperature sensor, the camera and the cellular line to communicate via Wi-Fi or Bluetooth or a software program that is written to trigger a siren or an alarm when a temperature is out of the programmed parameters and there is a living object present in a car or in a house or a software program written and programmed to trigger a siren when a motion sensor detects an intruder or a living object near or inside a swimming pool.

11. An asset tracking system aided by an embedded sim card with an activated cellular line and a gps antennae with the necessary hardware components incorporated in the micro-controller or outside the micro-controller to perform the above stated functions.
